(19) United States
(12) Patent Application Publication
(10) Pub. No.: US 2018/0244024 A1
(43) Pub. Date: Aug. 30, 2018

(54) MONOAXIALLY OR BIAXIALLY ORIENTED POLYOLEFIN RELEASE FILM

(71) Applicant: TORAY PLASTICS (AMERICA), INC., North Kingstown, RI (US)

(72) Inventor: Masato USHIJIMA, Narragansett, RI (US)

(21) Appl. No.: 15/442,318

(22) Filed: Feb. 24, 2017

(51) Int. Cl. B32B 27/32; B32B 27/30; B32B 15/085

(52) U.S. Cl. CPC B32B 27/32; B32B 27/308; B32B 15/085; B32B 2255/06; B32B 2307/518; B32B 2405/00; B32B 2307/516

(57) ABSTRACT

A release film including a monoaxially or biaxially oriented multilayer polyolefin-based film having a crystallizable polyolefin core film layer and at least one coextruded skin layer having a poly-4-methyl-1-pentene composition blended with an olefin copolymer elastomer modifier. The film's release surface has a peeling force value of 1500 g/inch or less and a 60° angle surface gloss of below 50 gloss units (GU). An embodiment is a film structure having (a) a metal transfer carrier film having polyolefin as described above and (b) a coated metal layer having a metal layer and a coating layer, wherein the coating layer lies between the metal layer and the metal transfer carrier film, wherein the metal transfer carrier film is configured to allow transfer of the coated metal layer onto a substrate, so that after transfer of the coated metal layer onto the substrate, the coating layer is located on top of the substrate.

### FIELD OF INVENTION

The invention relates to a release film structure, containing a monoaxially or biaxially oriented multilayer polyolefin-based film comprising a crystallizable polyolefin (e.g., polypropylene homopolymer) core film layer and at least one coextruded skin layer comprising a poly-4-methyl-1-pentene composition blended with an olefin copolymer elastomer modifier that prevents delamination of the skin layer. This film has excellent and stable release properties suitable for use as release film substrate for hot-molded items, metal transfer, and composite prepreg items.

### BACKGROUND OF INVENTION

Release films are in general films with at least one surface (“release surface”) characterized by low surface energy that serve to protect and allow handling various materials and articles, such as adhesives or articles coated with an adhesive, which in the final application can be easily separated from the release film substrate due to weak adhesion of the release film surface to the adhesive, and transferred by bonding permanently to another surface. Examples are injection-molded and composite parts, pressure-sensitive adhesive labels, and various films used as protective overlaminates. A special case is the metal-transfer from a metalized release film onto an adhesive-coated paper substrate for creating metal decoration of e.g., a paperboard package for cosmetics, tobacco, and beverages. They are also used as release mold liners in certain molding applications involving thermoset molding in order to protect the mold in autoclave or vacuum bag thermoset molding when parts are processed under high temperature and pressure. As an inert, non-stick film, release liners provide an excellent, quick release from epoxy, phenolics, polyesters and rubber compounds.

One of the first film materials that have found use as release films are fluoropolymers, for example Dupont's Tedlar® polyvinyl fluoride films (PVF). However, they are high cost and they have a relatively high release force which makes them unsuitable for many end-uses.

Another type of release film is silicone-coated mono or biaxially oriented polyester (BOPET) or polypropylene (BOPP) films. These can have very low release force but the presence of silicone presents a problem with recyclability of the release film after application; also, residual low molecular weight silicone moieties have a tendency to transfer over to the material being released which have the potential to cause further downstream processing problems.

Poly-4-methyl-1-pentene (“PMP”) is considered to be another suitable candidate resin for making a release film. The linear formula for PMP is (CH₂CH[CH₂CH(CH₃)₂])ₙ and the structural formula for PMP is:

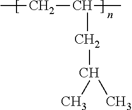

Other than fluoropolymers, PMP resin has the lowest surface energy (surface tension) of all commercially known resins and particularly polyolefins (including, in the order of increasing surface tension, high density polyethylene (HDPE), polypropylene (PP), polyvinylchloride (PVC), polysulfone (PSU), poly(ethylene terephthalate) (PET), polycarbonate (PC), and nylon 66 polyamide (PA66). It is second only to polytetrafluoroethylene (PTFE). The comparison is as follows:

| Polymer | Surface Tension (mN/m) |
|---|---|
| PTFE | 20 |
| PMP (“TPX ™” from Mitsui Chemicals) | 24 |
| HDPE | 32 |
| PP | 34 |
| PVC | 39 |
| PSU | 41 |
| PET | 43 |
| PC | 43 |
| PA66 | 46 |

Monolayer PMP films, essentially 100% PMP, have found application as release films; however, they possess the disadvantage that they are expensive and that they are only available in the unoriented extruded state, i.e., they cannot be monoaxially or biaxially oriented, which limits their strength and applicability. One example of monolithic unoriented PMP-based (Mitsui TPX™) release film is Opulent™ X-44B, supplied by Mitsui Chemicals.

One step towards reducing cost of the PMP-based solution is a co-extruded multilayer film with the PMP providing the release functionality located in the skin layer(s). Such films are also available by Mitsui Chemical, for example under trade name Opulent™ CR1012. However, this family of films is also non-oriented, resulting in limitations with respect to downgauging and also tensile strength. Such release films, with polyamide in the core and PMP in the skin are described in U.S. Pat. No. 6,270,909 and also in U.S. Pat. No. 6,265,083 for release films with a polypropylene core and PMP skin. These multilayer films are also non-oriented (extruded cast films). It is apparent that delamination between the PMP skin and the core is an issue, probably related to the low surface energy of PMP. In the above two patents this is resolved by adding a bonding (adhesive) layer between the PMP skin and the polymer core.

U.S. Pat. No. 7,314,905 discloses a monoaxially drawn film with a PMP skin but delamination after drawing is still an issue and is actually used as an advantage in that case, providing a way to make thin monoaxially oriented PMP film by delaminating the PMP skin from the core layer.

One problem with mono- or biaxial orientation of multilayer films with PMP in the skin layer and a polyolefin (such as polypropylene) in the core layer is delamination tendency due to incompatibility at the PP/PMP interface. An obvious direction towards solving this problem is to incorporate by blending some PP in the PMP skin layer. Mitsui has disclosed technology involving PMP/PP blend in the skin on top of a PP main or core layer. The main end-use target of that development is a cast film or sheet for thermoforming and the advantage versus a PP monolayer sheet is superior thermal resistant of the food-contact (PMP/PP) blend in microwave cooking. However, the inventors have found that even such a blend is prone to delamination from a PP core.

It is therefore desirable to provide a film that delivers the advantages of a PMP release surface, while at the same time being cost-effective, mono- or biaxially oriented, and with little or no delamination between the respective layers.

Metalized film compositions allowing metal transfer from a carrier film to a permanent adhesive-coated substrate (e.g., adhesive coated cardboard) have been described, for example, in US Patent Publication No. 20140124128. The metal layer is in direct contact with the polyester carrier film and no intermediate release layer is present. Desired metal adhesion is provided by dispersing a suitable surfactant, and optionally, a hydrocarbon wax, uniformly into the polyester film. Such films take advantage of the weak metal adhesion to the carrier film. However, they do not allow the flexibility of adding an additional coating layer, e.g., a hardcoat, between the metal layer and the carrier film, because that layer (along with the metal) does not transfer. In this process, the hardcoat layer is added as a separate processing step (such as off-line coating method) on top of the metal layer, once the metal layer has been permanently transferred to the adhesive-coated substrate.

There is therefore a need in the industry for a metal transfer carrier film configured to allow metal transfer of a coated metal layer having a metal layer and a coating layer, wherein the coating layer lies between the metal layer and the metal transfer carrier film, so that after transfer of the coated metal layer onto the substrate, the coating layer is located on top of the substrate.

### SUMMARY OF THE INVENTION

An embodiment relates to a film comprising (a) a metal transfer carrier film comprising polyolefin and (b) a coated metal layer comprising a metal layer and a coating layer, wherein the coating layer lies between the metal layer and the metal transfer carrier film, wherein the metal transfer carrier film is configured to allow transfer of the coated metal layer onto a substrate, so that after transfer of the coated metal layer onto the substrate, the coating layer is located on top of the substrate. Preferably, the coating layer comprises a blend of poly-4-methyl-1 pentene resin and an olefin containing elastomer, wherein the olefin copolymer elastomer is miscible or compatible with the polyolefin in the metal transfer carrier film. Preferably, the coating layer comprises a blend of 50-97 wt % of poly-4-methyl-1 pentene resin and 3-50 wt. % of an olefin containing elastomer, wherein the olefin copolymer elastomer is miscible or compatible with the polyolefin in the metal transfer carrier film.

Yet another embodiment relates to a polyolefin-containing film comprising a base layer, the base layer comprising a first polyolefin resin, and at least a first skin layer on top of the base layer, the first skin layer comprising a blend of 50-97 wt % of poly-4-methyl-1 pentene resin and 3-50 wt. % of an olefin containing elastomer, wherein the olefin copolymer elastomer is miscible or compatible with the first polyolefin resin. Preferably, the first polyolefin resin is at least partially crystallizable. Preferably, the first polyolefin resin comprises a polypropylene homopolymer. Preferably, the olefin containing elastomer comprises an olefin copolymer elastomer, wherein the olefin copolymer elastomer has two or more different monomer units.

In yet another embodiment, the polyolefin-containing film could further comprise a second skin layer. Preferably, the second skin layer possesses a different concentration of the poly-4-methyl-1-pentene than that in the first skin layer. Preferably, the second skin layer possesses a different concentration of the olefin copolymer elastomer than that in the first skin layer. Preferably, the second skin layer possesses a second polyolefin resin that is different from the poly-4-methyl-1 pentene resin and the olefin copolymer elastomer. Preferably, the first skin layer also possesses the second polyolefin resin in an amount that is different that contained in the second skin layer. Preferably, the second polyolefin resin in the second skin layer comprises a polypropylene homopolymer. Preferably, the at least the first skin layer is coated with a coating formulation which, after metallization, is configured to transfer over to an adhesion-coated substrate. Preferably, the at least the first skin layer is coated with a coating formulation which, after metallization, is configured to transfer over to an adhesion-coated substrate. Preferably, the olefin containing elastomer comprises a random copolymer that is amorphous and/or has a melting point below 100° C., wherein the random copolymer has two or more different monomer units. Preferably, the random copolymer comprises an olefin monomer and an α-olefin monomer different from the olefin monomer, wherein a mole fraction of the α-olefin monomer is between 0.1-0.5. Preferably, the mole fraction of the α-olefin monomer is between 0.2-0.3. Preferably, the random copolymer comprises an ethylene repeat unit and a propylene repeat unit, wherein the amount of the ethylene repeat unit is greater than or equal to the amount of the propylene repeat unit. Preferably, the random copolymer comprises an ethylene repeat unit and a 1-butene repeat unit, wherein the amount of the ethylene repeat unit is greater than or equal to the amount of the 1-butene repeat unit. Preferably, the random copolymer comprises a polymer having the general formula: —[—CH2-CHR1-]m-[-CH2-CHR2-]n- wherein R1 is H or an alkyl group and R2 is different than R1. Preferably, the alkyl group comprises a methyl group or an ethyl group. Preferably, R2 comprises a methyl group or an ethyl group. Preferably, the film has a peeling force value of 1500 g/inch or less. Preferably, the 60° angle surface gloss of the first side is below 50 gloss units (GU). Preferably, the 60° angle surface gloss of the first side is below 20 gloss units (GU). Preferably, the coating formulation comprises an acrylic resin. Preferably, the acrylic resin comprises a translucent liquid that is a self-cross-linking acrylic co-polymer emulsion.

### BRIEF DESCRIPTION OF THE DRAWINGS

FIG. 1 shows a one-sided release film 10 having two layers (a/b structure): a skin layer 10a comprising a blend of PMP and olefin copolymer elastomer and a core layer 10b comprising a polyolefine resin, preferably a crystallizable polyolefin resin such as polypropylene homopolymer.

FIG. 2 shows a two-sided differential release film 20: a skin layer 20a comprising a blend of PMP and olefin-based elastomer, a core layer 20b comprising a polyolefine resin, preferably a crystallizable polyolefin resin such as polypropylene homopolymer, and a second skin layer, 20c, comprising PMP (at identical or different load to side 20a) olefin copolymer elastomer (at identical or different loading to layer 20a, and optionally a. a crystallizable poloyolefin resin, such as polypropylene homopolymer.

FIG. 3 shows a two-sided differential release film 30: a three layer coextruded structure like that in of FIG. 2 (shown as 30a/30b/30c) but there is an additional layer 31 on top of skin layer 30a.

FIG. 4 shows two-sided differential release film wherein the layer 31 is a coating layer (for example hardcoat protection); layer 31 has a metalized layer that is transferred onto a permanent substrate (coated with adhesive).

### DETAILED DESCRIPTION OF THE INVENTION

An embodiment of the invention is to solve the aforesaid problems of structures comprising skin comprising PMP coextruded on top of PP-comprising base layer, namely: delamination of the PMP-comprising skin from the PP-comprising base layer and inability of biaxial orientation of such coextruded cast films. One aspect of the present invention is a polyolefin-based co-extruded and mono- or biaxially oriented film with a release surface achieved by incorporating PMP in the skin layer comprising at least 2 layers: a) a PMP-based resin skin layer displaying robust adhesion to the base polyolefin layer characterized by absence of delamination of the skin layer; (b) a crystallizable polyolefin (e.g., PP homopolymer)-based core layer.

According to an embodiment of the invention, the above embodiment is achieved by a PMP-based skin layer modified by blending with an olefin copolymer elastomer that is miscible or compatible with the polyolefin of the base layer, preferably an amorphous or low-melting point (i.e., below that of low density polyethylene), i.e., below about 100° C.); preferably a high α-olefin-content random copolymer. An example of such an olefin elastomer is Tafmer™ A series resins from Mitsui Chemicals. Tafmer™ resins are propylene-butene, ethylene-butene, or ethylene-propylene plastomers or elastomers. It was unexpectedly found that a Tafmer™ content as low as 10 wt. % used in the PMP-based skin layer is adequate for preventing delamination of said skin from the PP-based core layer.

Another embodiment of the invention is a polyolefin-based release film with a matte surface approaching a paper-like texture, accomplished by the blending of PMP with the olefin copolymer elastomer. Matte appearance is quantified by a 60° surface gloss of 50 gloss units (GU) or less.

Yet another embodiment of the present invention is a metalized structure, with the metal layer vapor-deposited on the outer surface of a release layer comprising the PMP/olefin copolymer elastomer; this structure allows metal transfer to a substrate, e.g., cardboard or paperboard that has been coated with adhesive.

Yet another embodiment of the present invention is a metalized and coated structure with the metal layer vapor-deposited on top of the coating layer (for example a hard-coating composition), which in turn is deposited on the release film structure comprising a layer comprising the PMP/olefin copolymer elastomer; this structure allows transfer of not only the metal layer but also the underlying hard-coat layer onto a substrate, e.g., cardboard coated with an adhesive.

Yet another embodiment of the present invention is release films featuring a release surface on both sides, characterized by “differential release”, i.e., each of the two sides demonstrating different release strength. This is accomplished by varying the olefin copolymer elastomer ratio or incorporating crystallizable polyolefin resin. Differential release is required when the release film is used to carry an exposed adhesive layer and when, after adhesive application, is wound into an intermediate roll. The release capability of the side opposite to that carrying the adhesive facilitates unwinding (without sticking to the exposed adhesive) whereas the release capability of the side carrying the adhesive facilitates transfer of the adhesive onto a permanent substrate. For proper operation, the release force in the former case is lower than that in the latter.

An embodiment of the invention is related to co-extruded release films. Release films are available in two primary types: one-side release; and two-side or differential release. Both carry and protect an adhesive until it is time for application at its end use and are specially formulated to have the suitable surface energy to pull away while leaving the adhesive fully intact and functional. One-side release films and two-side differential release films have specific functional requirements, and there are key distinctions between these functions. One-side liners carry an adhesive that is laminated to a film or paper substrate on the other side, e.g., a pressure-sensitive adhesive label. These one-side release liners primarily serve as a delivery mechanism for adhesive-coated labels for automatic or manual labeling and graphic arts applications. In comparison, differential (two-sided) release liners are typically used to carry an adhesive that must be wound together with the release liner upon itself and then unwound for use. In such a wound roll, both surfaces of the adhesive film are contacting the two surfaces of a release liner. To work properly, the release film must have two different release values (surface energies) for proper performance. That release value is the force needed to remove an adhesive product from a release liner surface. This force is closely related to the surface energy. This liner construction enables the adhesive tape to easily be rolled, unrolled and applied without the adhesive “confusing” or sticking to the wrong side of the differential release liner. Adhesive confusion occurs when the double-sided adhesive tape does not “recognize” from which side to release first. Instead, the tape jumps during the unwinding process from one release liner surface to the other. As a result, the adhesive tape is usually damaged and rendered essentially useless.

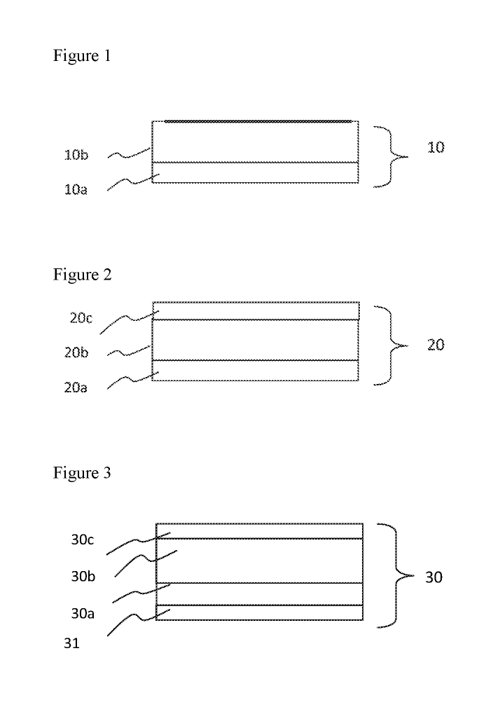

Embodiments of the invention are illustrated in the structures shown in FIGS. 1-4.

In the embodiment shown in FIG. 1 (one-sided release film 10) the release film comprises two layers (a/b structure): a skin layer 10a comprising a blend of PMP and olefin copolymer elastomer and a core layer 10b comprising a polyolefine resin, preferably a crystallizable polyolefin resin such as polypropylene homopolymer.

The term “polyolefin” refers to any of a class of polymers produced from a simple olefin (also called an alkene with the general formula CₙH₂ₙ) as a monomer. For example, polyethylene is the polyolefin produced by polymerizing the olefin ethylene. Polypropylene is another common polyolefin which is made from the olefin propylene.

The term “polypropylene homopolymer” refers to a polyolefin that contains substantially entirely of propylene repeat units —[—CH₂—CH(CH₃)—]—. The term “contains substantially” indicates that the resin formulation may contain small amount (less than 1 wt. %) of additives, such as nucleating agents, thermal and oxidation stabilizers, light stabilizers, etc.

The term “crystallizable polyolefin” refers to a polyolefin that is capable of developing crystallinity upon cooling from the molten state to at least a degree. Crystallinity involves a regular repeating arrangement of the molecules. To produce a crystal, the polymer chains must be capable of packing closely together in a regular, parallel array. Linear polymers made of symmetrical monomers, such as polyethylene, crystallize easily. Asymmetric linear polymers such as polypropylene crystallize only if the configuration is regular.

The formation of crystals requires polymer chain mobility; once a certain degree of crystallinity is attained (which depends on the temperature at which crystallization is taking place) further mobility is restricted so the remaining of the polymer remains in non-crystal state (“amorphous”). Thus the term “degree of crystallinity” reflects the relative amount of crystalline regions and amorphous regions.

In the embodiment shown in FIG. 2, (two-sided differential release film 20) the release film comprises three layers: a skin layer 20a comprising a blend of PMP and olefin-based elastomer, a core layer 20b comprising a polyolefine resin, preferably a crystallizable polyolefin resin such as polypropylene homopolymer, and a second skin layer, 20c, comprising PMP (at identical or different load to side 20a) olefin copolymer elastomer (at identical or different loading to layer 20a, and optionally a. a crystallizable poloyolefin resin, such as polypropylene homopolymer.

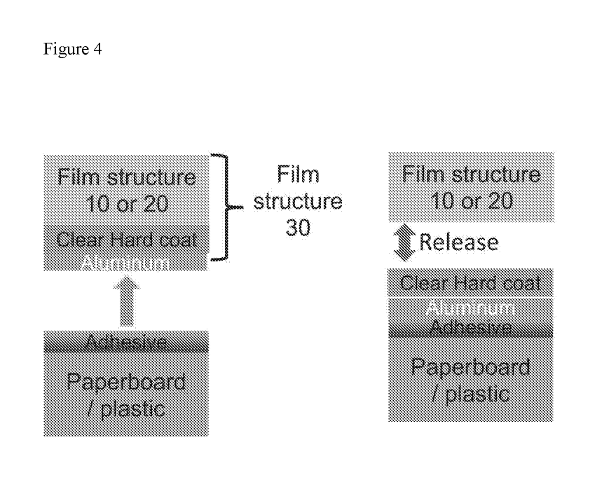

In the embodiment shown on FIG. 3 (two-sided differential release film 30), a three layer coextruded structure like that in of FIG. 2 appears again (shown as 30a/30b/30c) but there is an additional layer 31 on top of skin layer 30a. Layer 31 is a coating layer (for example hardcoat protection) that can be applied by either in-line or off-line aqueous suspension coating, followed by water evaporation by applying heat, or offline by solution coating, followed by solvent evaporation by applying heat, or offline by melt extrusion coating. This layer in turn can be metalized, e.g., by aluminum vacuum deposition. Upon release on a permanent substrate, the aluminum coated with the coating is transferred onto the permanent substrate (coated with adhesive), as shown in FIG. 4. In the case the coating is applied in-line a single release layer, situated on one side of the base layer, is sufficient.

Another embodiment of the invention is the incorporation of the olefin-copolymer elastomer resin in the skin layer of a release film comprising PMP, that is miscible or compatible with the crystallizable polyolefin resin in the base layer. The term “miscible” polymers refers to polymers that form homogeneous blends at the molecular level when combined, leading to single-phase structure. This structure is characterized by a single glass transition temperature. The term “compatible” polymers refer to polymers that form a heterogeneous blend (two phases) but characterized by a uniform phase dispersion of one phase (discrete phase) forming discrete domains in a “sea” of the second phase (continuous phase) wherein the discrete phase domains have a short dimension in the sub-micron range and good interfacial adhesion to the continuous phase. This structure is characterized by uniform macroscopic properties. On the other hand “incompatible” polymers are those that when blended form heterogeneous blends with large unevenly distributed and poorly adhering phases.

The incorporation of the olefin-copolymer elastomer resin in the skin layer is capable of facilitating good adhesion (no delamination) to the underlying core layer (crystallizable polyolefein, e.g., polypropylene). Olefin copolymer elastomers are in general random copolymers of two or more different olefin resins, with the olefin resin constituting the minor component present at a weight fraction 10%-50%. An example of an olefin-based elastomer resin is Tafmer™ A series resin from Mitsui Chemicals. It was unexpectedly found that a Tafmer™ content as low as 10 wt. % of the PMP-containing release layer is adequate for preventing delamination from the core layer. The Tafmer™ family of resins is produced by metallocene-catalyzed copolymerization of an olefin (such as ethylene, propylene or 1-butene) with an α-olefin represented by the general formula H₂—C═CHR, R being an alkyl group such as methyl, ethyl, etc. The resulting copolymer has the general formula —[—CH2-CHR₁—]ₘ—[—CH₂—CHR₂—]ₙ— (where R₁ is H or an alkyl group such as methyl or ethyl and R₂ is also an alkyl group such as methyl or ethyl but different than R₁). The first repeat unit in the above formula is the “olefin monomer” and the second repeat unit is the “α-olefin monomer”. The mole fraction n of the α-olefin monomer is typically in the order 0.1-0.5 preferably 0.2-0.3. The weight fraction m of the olefin monomer is simply equal to 1-n. Compared to LLDPE, these elastomers are characterized by high comonomer content, low or no crystallinity, and very low density (0.86-0.89 g/cm³). Particularly preferable variations of Tafmer™ resins are Tafmer™ grades A4085S (ethylene/1-butene based, i.e., R₂ is —CH₂CH₃), A-4070S (ethylene/1-butene-based), PN-3560 (ethylene-propylene-based, i.e., R₂ is —CH₃).

For good release properties, a PMP content of 50-97 wt %, of the release layer, is required. Examples of suitable PMP materials are resin grades from Mitsui Chemical under the “TPX™” trade name family. These materials are polymers of the olefin named 4-methylpentene-1. The resulting polymer has a bulky side chain, which upon crystallization forms a 72 helical crystal structure. These characteristics provide unique features, namely limited molecular movement, resulting in a melting point among the highest among polyolefins: 220-240° C.; very small density difference between the crystal and amorphous phase accompanied by high transparency after thermal crystallization; low packing density between molecules resulting in low density (0.83 g/cc) and low surface tension (as shown in the surface tension numbers on Table 1), resulting in good releasability. Examples of film-grade polymers in the TPX™ family are grades MX002, MX004, DX845, RT18. They vary primarily in terms of molecular weight which translates into two different values of the Melt Flow Rate (MFR), measured at 260° C. under a load of 5 kg (20, 25, 9.5, and 26 g/10 min respectively). Grade MX004 was used in the examples but other grades are possible for suitable use as well.

PMP (e.g., TPX™) loading ratio has a negative correlation relationship with release force. The more PMP, the lower the release force.

Olefin elastomer (e.g., Tafmer™) has a positive correlation relationship with surface roughness: with increasing Tafmer™ levels surface roughness resulting in almost paper-like appearance can be produced.

Skin layers may include various additives well-known as additives for polypropylene, for example, stabilizers, anti-oxidants, ultra-violet absorbers, plasticizers, antistatic agents, anti-blocking agents, slip agents, organic lubricants, pigments, coloring agents, nucleating agents, etc. without affecting significantly the novel properties of the film. Similarly, other kinds of polymers known as suitable for mixing into polypropylene may be added, for example, polyethylene, polybutene-1, poly(4-methylpentene-1), copolymers of polypropylene (i.e., ethylene-propylene, propylene-butene, and ethylene-propylene-butene copolymers), etc. These may be added by mixing in an amount of about 0.1 to 5 wt % based on the weight of the mono- or biaxially oriented layer. Silicone containing additives may also be added for enhancing release property (reducing tape peeling force). In a preferred embodiment, the skin layers have a thickness that is 30%, preferably 15%, more preferably 10% of the total film thickness.

### EXAMPLES

### Raw Materials

### Crystalline Polypropylene Homopolymer Resins:

LX11306 from Total Petrochemical, having Melt Flow Index (measured at 230° C. under a weight of 2.16 kg) of 2.0 g/10 min.

H03BPM from NATPET (National Petrochemical Industrial Co.) having Melt Flow Index (measured at 230° C. under a load of 2.16 kg) of 3.0 g/10 min.

### Poly-4-Methyl-1-Pentene (“PMP”) Resin:

TPX™ MX004 from Mitsui Chemical with Melt Flow Rate 25 g/10 min measured at 260° C. under a load of 5 kg.

Olefin Copolymer elastomer (High α-olefin-content random copolymer).

Tafmer™ A4085S (ethylene/1-butene random copolymer made with metallocene catalyst) from Mitsui Chemicals, having melt flow rate (at 190° C. under a load of 2.16 kg) 3.6 g/10 min and a density of 885 g/cm³, and a melting point of 66° C.

Tafmer™ A4070S (ethylene/1-butene random copolymer made with metallocene catalyst) from Mitsui Chemicals, having melt flow rate (at 190° C. under a load of 2.16 kg) 3.6 g/10 min, a density of 870 g/cm³, and a melting point of 55° C.

### Hardcoat Formulation

Liquid acrylic compound DSM Coating Resins LLC, NeoCryl® A-1127, supplied as 44% non-volatile solids suspension in water. NeoCryl® A-1127 is a yellowish translucent liquid that is a self-cross-linking acrylic co-polymer emulsion. It is for flexo and gravure printing and offers excellent chemical resistance and good adhesion properties on a variety packaging films. The recommendations on formulation and use for NeoCryl® A-1127 includes surface printing onto polyolefin's and heavy duty PE printing.

### Procedures

### Multilayer Film Production

Example films were made by the following process: A three layer (A/B/C) type film was coextruded through three different extruders providing layers A, B, and C respectively. Layers A and C were the release skin layers encapsulating the core layer B. The blend composition of each layer is shown on Table 1. The extruder speeds (RPM) were adjusted to provide the desired respective thickness ratio. Each extruder comprised a series of heating zones and indicative temperature settings (starting with feed zone and ending with exit zone) were as follows:

### Extruder A: 490/500/500° F.

### Extruder B: 450/480/480/480/480° F.

### Extruder C: 490/500/500° F.

The extrudate was cast on a pair of casting drums arranged in tandem and chilled at a temperatures of 180° F. and 80-100° F.; an air knife (“A/K”) was positioned above the first casting drum such that it ensured flat film formation.

Subsequently the cast film was stretched in the machine direction (“MD”) by a set of heated rolls, heat-set or annealed to relax the MD-oriented film lengthwise and to minimize residual stresses and minimize heat shrinkage; and then stretched along the transverse direction (“TD”) in a tenter oven (“Stenter”). The transversely stretched film was also heat-set or annealed to reduce residual stresses in the biaxially oriented film and to minimize thermal dimensional shrinkage. Stretch and relaxation ratios for both MD and TD orientation rates are indicated in Table 1. Indicative stretch and relaxation temperature conditions were set as follows:

MDO: Preheat Roll 1: 230° F./Preheat Roll 2: 275° F./Slow Draw Roll: 284° F./Fast Draw Roll: 275° F./Anneal Roll: 180° F./Cooling Roll: 80° F.

TDO: Oven Zone 1 (preheat zone): 320° F./Oven Zone 2 (stretching zone): 320° F./Oven Zone 3 (annealing zone): 310° F.

Typical cast speed was 20 fpm and final line speed was dictated by the selected MDO draw ratio/relaxation ratio, as shown in Table 1. Extruder RPMs were adjusted accordingly to provide the desired thickness profile: in all the examples overall film thickness was around 0.9 mil (23 μm after transverse orientation but the films of the embodiments of the invention can range in general between 20-100 μm). Each skin layer is set as a percentage of the total film cross-sections to values up to 30%, preferably 15%, more preferably 10% of the total thickness.

### Test Protocol

Surface gloss: Surface gloss was measured at 600 angle according to ASTM D 523 using a Micro TRI-Gloss Meter from BYK-Gardner. Three individual measurements along the machine direction of film formation (MD) and three along the transverse direction (TD) were conducted. The overall average of all six measurements is reported. The results are expressed in dimensionless Gloss Units (GU).

Surface energy was determined by using the known numerical relationship between surface tension in dynes/cm of a polymer surface and the contact angle of a distilled water drop deposited onto the surface (Zisman correlation). The contact angle was measured using a Contact Angle Meter (from Tantec, Schaumburg, Ill.) as described in U.S. Pat. No. 5,268,733, which is incorporated herein by reference in its entirety.

Surface Roughness: Film roughness was measured on a Kosaka Laboratory Surfcorder™ SE-500. The resulting values, Ra and Rz (in nm) refer to averages, calculated by the testing equipment as follows: Ra is the arithmetical average value of all absolute distances of the roughness profile from the center line within the measuring length. Rz is the average maximum peak to valley of five consecutive sampling lengths within the measuring length.

Tape Peeling Force Test: The method consists of cutting film strips in dimensions 50 mm×100 mm and applying a special type of adhesive tape (Tesa Tape, Inc. TESA 7475) on top of each sample (in triplicate). Consistent pressure is applied on each tape to facilitate adhesion onto the release film by rolling over it a 2 kg roller once with a steady hand motion. Subsequently, the samples with the tape attached are allowed to cure for 24 hours at ambient conditions (i.e., room temperature). Subsequently, the tape release force is measured on a Release Tester, model AR-1000, from Cheminstrument, at jaw separation speed 300 mm/min and angle of peel 180°.

Metal Peeling Test: Film samples were metalized in a bell jar laboratory vacuum deposition chamber to a metal layer thickness 100-350 Å (Angstrom units). Metal adhesion was evaluated by applying 3M tape (No. 610) by hand, and stripping by hand to check appearance after attempted transfer of the metal on to the tape. The appearance was rated visually as follows:

Good: 90˜100% metal transfer
Fair: 70˜90% metal transfer
Poor: 0˜70% metal transfer

“Metal transfer” means that when one peels the adhesive tape from the metalized film, the metal layer prefers to peel away from the film substrate and stay with the tape. It is a well known technique in the art of decorating “metal transfer.”

### Comparative Examples and Examples

### Comparative Example 1

(No Tafmer™ in the skins) A three layer (A/B/C) type film was extruded through three different extruders providing layers A, B, and C respectively as described previously. The blend composition of each layer is shown on Table 1.

The film was tested for gloss, surface roughness, surface tension, and tape peeling force, and metal peeling force by hand. The test results are shown in Table 2.

### Example 1

The film-making procedure of Comparative Example 1 was repeated but with Tafmer™ present in the skins and with 50% TPX™ present in the skins as well; the layer compositions were as shown in Table 1. The same properties as in Comp. Example 1 were tested and shown on Table 2. As indicated by comparing the properties of Example 1 vs. Comp. Example 1, the addition of 10 wt % Tafmer™ elastomer in the PMP-containing release layer of Example 1 eliminated the delamination issue experienced in Comp. Example 1 upon tape release. Comparing the gloss and roughness ratings (and also visual observation) shows that the presence of Tafmer™ elastomer also produced a rougher surface and almost matte appearance, especially on the surface side of layer A where the presence of Tafmer™ elastomer (layer A blend) is higher. Finally comparing the release force (tape peeling force) between sides A (layer A blend) and side B (layer C blend) resulted in differential release properties between the two skin layers.

### Example 2 (Tafmer™ in Skins)

The film-making procedure of Example 1 was repeated but with a higher level of TPX™ and a lower level of Tafmer™ in the skins. the layer compositions were as shown in Table 1. The A-side testing results (tape peeling force) indicate the lowest peeling strength amongst the examples, resulting from maximizing TPX™ content. At the same time, surface gloss is higher and surface roughness is lower than Example 1, correlating with the lower Tafmer™ content in the skins.

Example 3 (Tafmer™ elastomer plus hard-coat inline coating). The film-making procedure of Example 1 was repeated but in addition there was inline coating (between the MDO and the TDO section, a gravure coater is used to apply an aqueous hard-coat composition based on acrylic resin NeoCryl® A-1127 of 44% NVS (non-volatile solids) upon the outer surface of the extruded skin layer A. This coating is then dried and oriented transversely in the stenter oven to form a dried coating of ca. 0.10-1.0 um thick, preferably 0.25-0.5 um). The testing results (tape peeling force) indicate that the coating was transferred onto the tape upon peeling, which is a desirable attribute for transfer of metal coated with hard-coat. After metalizing, metal transfer performance was better on the coated side.

The above description is presented to enable a person of ordinary skill in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

All US patents and publication mentioned in this application are incorporated herein in their entirety by reference.

TABLE 1

| | Layer A | | | | | | | |
|---|---|---|---|---|---|---|---|---|
| | (Casting | | Layer C | | | | | Film |
| | Drum | Layer B | (Air Knife | | | | | thickness |
| | Side) | (Core) | Side) | | | | Line | after |
| | Composition | Composition | Composition | | MD | TD | Speed, | orientation, |
| Example | (wt %) | (wt %) | (wt %) | Coating Application* | Ratio | Ratio | fpm | mil |
| Comp. | 47% | 100% Total | 47% | Off | Stretch: | Stretch: | 89.3 | 0.9 |
| Ex. 1 | TPX ™ | LX11306 | TPX ™ | | 4.75 | 8.0 | | |
| | MX004 | | MX004 | | Relax: | Relax: | | |
| | 53% Total | | 53% Total | | 0.92 | 0.90 | | |
| | LX11306 | | LX11306 | | | | | |
| Ex. 1 | 50% | 100% Total | 50% | Off | Stretch: | Stretch: | 89.3 | 0.9 |
| | TPX ™ | LX11306 | TPX ™ | | 4.75 | 8.0 | | |
| | MX004 | | MX004 | | Relax: | Relax: | | |
| | 50% | | 30% | | 0.92 | 0.90 | | |
| | Tafmer ™ | | Tafmer ™ | | | | | |
| | A4085S | | A4085S | | | | | |
| | | | 20% Total | | | | | |
| | | | LX11306 | | | | | |
| Ex. 2 | 90% | 100% | 75% | Off | Stretch: | Stretch: | 89.3 | 0.9 |
| | TPX ™ | NATPET | TPX ™ | | 4.75 | 8.0 | | |
| | MX004 | H03BPM | MX004 | | Relax: | Relax: | | |
| | 10% | | 15% | | 0.92 | 0.90 | | |
| | Tafmer ™ | | Tafmer ™ | | | | | |
| | A4070S | | A4070S | | | | | |
| | | | 10% | | | | | |
| | | | NATPET | | | | | |
| | | | H03BPM | | | | | |
| Ex. 3 | 90% | 100% | 75% | On (Without Corona) | Stretch: | Stretch: | 89.3 | 0.9 |
| | TPX ™ | NAT PET | TPX ™ | | 4.75 | 8.0 | | |
| | MX004 | H03BPM | MX004 | | Relax: | Relax: | | |
| | 10% | | 15% | | 0.92 | 0.90 | | |
| | Tafmer ™ | | Tafmer ™ | | | | | |
| | A4070S | | A4070S | | | | | |
| | | | 10% | | | | | |
| | | | NATPET | | | | | |
| | | | H03BPM | | | | | |

*Off and On mean either the coating application is switched on or switched off.

TABLE 2

| | | | Comp. Ex. 1 | Ex. 1 | Ex. 2 | Ex. 3 |
|---|---|---|---|---|---|---|
| Surface Gloss | | A-side | 72 | 18 | 42 | 42 |
| | | B-side | 76 | 12 | 23 | 68 |
| Surface | Ra | A-side | 65 | 700 | 108 | 35 |
| Roughness | | B-side | 90 | 270 | 209 | 182 |
| (nm) | Rz | A-side | 970 | 8600 | 1809 | 605 |
| | | B-side | 2190 | 3300 | 2062 | 4057 |

| | | | | | |
|---|---|---|---|---|---|
| Surface | A-side | 27 | 16 | 28 | 28 |
| Tension (dyne) | B-side | 26 | 24 | 25 | 26 |
| Tape Peeling | A-side | 100% | 1210 | 185 | Delamination |
| Force (g/in) | | Delamination | | | between |
| | | between skin | | | coating and |
| | | layer and base | | | base film |
| | B-side | layer | 950 | 1282 | 896 |
| Metal Peeling | A-side | | Good | Fair | Good |
| Test by hand | B-side | | Poor | Fair | Fair |

Note:
“A-side” is the exposed side of layer A, unless there is a coating (Ex. 3) in which case it is the exposed side of the coating on top of layer A;
“B-side” is the exposed side of layer C.

1. A polyolefin-containing film comprising a base layer, the base layer comprising a first polyolefin resin, and at least a first skin layer on top of the base layer, the first skin layer comprising a blend of 50-97 wt % of poly-4-methyl-1 pentene resin and 3-50 wt. % of an olefin containing elastomer, wherein the olefin copolymer elastomer is miscible or compatible with the first polyolefin resin.

2. The film of claim 1, wherein the first polyolefin resin is at least partially crystallizable.

3. The film of claim 1, wherein the first polyolefin resin comprises a polypropylene homopolymer.

4. The film of claim 1, wherein the olefin containing elastomer comprises an olefin copolymer elastomer, wherein the olefin copolymer elastomer has two or more different monomer units.

5. The film of claim 1, further comprising a second skin layer.

6. The film of claim 2, whereby the second skin layer possesses a different concentration of the poly-4-methyl-1-pentene than that in the first skin layer.

7. The film of claim 2, wherein the second skin layer possesses a different concentration of the olefin copolymer elastomer than that in the first skin layer.

8. The film of claim 2, wherein the second skin layer possesses a second polyolefin resin that is different from the poly-4-methyl-1 pentene resin and the olefin copolymer elastomer.

9. The film of claim 5, wherein the first skin layer also possesses the second polyolefin resin in an amount that is different that contained in the second skin layer.

10. The film of claim 9, wherein the second polyolefin resin in the second skin layer comprises a polypropylene homopolymer.

11. The film of claim 1, wherein the at least the first skin layer is coated with a coating formulation which, after metallization, is configured to transfer over to an adhesion-coated substrate.

12. The film of claim 5, wherein the at least the first skin layer is coated with a coating formulation which, after metallization, is configured to transfer over to an adhesion-coated substrate.

13. The film of claim 1, wherein the olefin containing elastomer comprises a random copolymer that is amorphous and/or has a melting point below 100° C., wherein the random copolymer has two or more different monomer units.

14. The film of claim 13, wherein the random copolymer comprises an olefin monomer and an α-olefin monomer different from the olefin monomer, wherein a mole fraction of the α-olefin monomer is between 0.1-0.5.

15. The film of claim 14, wherein the mole fraction of the α-olefin monomer is between 0.2-0.3.

16. The film of claim 13, wherein the random copolymer comprises an ethylene repeat unit and a propylene repeat unit, wherein the amount of the ethylene repeat unit is greater than or equal to the amount of the propylene repeat unit.

17. The film of claim 13, wherein the random copolymer comprises an ethylene repeat unit and a 1-butene repeat unit, wherein the amount of the ethylene repeat unit is greater than or equal to the amount of the 1-butene repeat unit.

18. The film of claim 13, wherein the random copolymer comprises a polymer having the general formula:
—[—CH₂—CHR₁—]ₘ—[—CH₂—CHR₂—]ₙ—
wherein R₁ is H or an alkyl group and R₂ is different than R₁.

19. The film if claim 18, wherein the alkyl group comprises a methyl group or an ethyl group.

20. The film if claim 18, wherein R₂ comprises a methyl group or an ethyl group.

21. The film of claim 1, wherein the film's release surface or release surfaces have a tape peeling force value of 1500 g/inch or less.

22. The film of claim 1, wherein the 60° angle surface gloss of the first side is below 50 gloss units (GU).

23. The film of claim 22, wherein the 60° angle surface gloss of the first side is below 20 gloss units (GU).

24. The film of claim 11, wherein the coating formulation comprises an acrylic resin.

25. The film of claim 24, wherein the acrylic resin comprises a translucent liquid that is a self-cross-linking acrylic co-polymer emulsion.

26. A film comprising (a) a metal transfer carrier film comprising polyolefin and (b) a coated metal layer comprising a metal layer and a coating layer, wherein the coating layer lies between the metal layer and the metal transfer carrier film, wherein the metal transfer carrier film is configured to allow transfer of the coated metal layer onto a substrate, so that after transfer of the coated metal layer onto the substrate, the coating layer is located on top of the substrate.

27. The film of claim 26, wherein the coating layer comprises a blend of poly-4-methyl-1 pentene resin and an olefin containing elastomer, wherein the olefin copolymer elastomer is miscible or compatible with the polyolefin in the metal transfer carrier film.

28. The film of claim 26, wherein the coating layer comprises a blend of 50-97 wt % of poly-4-methyl-1 pentene resin and 3-50 wt. % of an olefin containing elastomer, wherein the olefin copolymer elastomer is miscible or compatible with the polyolefin in the metal transfer carrier film.
